(19) United States
(12) Patent Application Publication
(10) Pub. No.: US 2018/0212853 A1
(43) Pub. Date: Jul. 26, 2018

(54) GATEWAY FOR DISTRIBUTED CONTROL NETWORK

(71) Applicant: EMERALD INFORMATION SYSTEMS LTD., HAIFA (IL)

(72) Inventor: AMIR ALONI, HAIFA (IL)

(21) Appl. No.: 15/758,591

(22) PCT Filed: Sep. 11, 2016
(86) PCT No.: PCT/IL2016/051012

§ 371 Date: Mar. 8, 2018

Related U.S. Application Data
(60) Provisional application No. 62/216,408, filed on Sep. 10, 2015.

(51) Int. Cl. H04L 12/26; G05B 19/05; H04L 12/66; H04L 12/801; H04L 29/06

(52) U.S. Cl. CPC H04L 43/10; G05B 19/058; H04L 12/66; G05B 2219/24215; H04L 69/18; G05B 2219/1204; H04L 47/12

(57) ABSTRACT

A gateway configured to control and monitor a plurality of control elements (CE is provided that comprises application programming interface (API) for communicating with applications over the internet; libraries of CE's messages; and at least one interpreter utilized for translating the messages into an API protocol and vice versa.

### TECHNICAL FIELD

The present disclosure relates to data communicating in general, and to transferring data between different applications, in particular.

### BACKGROUND

Programmable logic controller (PLC) is a computer-based device that monitors and control physical processes. These processes include industrial, infrastructure, and facility-based processes such as: manufacturing, power generation, fabrication, water treatment, wastewater collection oil and gas distribution and large communication systems. These processes occur both in public facilities and private ones, including buildings, airports, ships, and outdoor facilities. Typically, PLCs also monitor and control facility environment, such as heating, ventilation, and air conditioning systems (HVAC), facility access, and energy consumption. Hence multiplicities of different processes occurring in parallel are calling for a plurality of PLCs where PLCs may be of different manufacturer and programmed differently.

A control and monitoring system may be combined with data and coded signals over communication channels utilized for obtaining information about the status of equipments as well as manipulating it through its dedicated PLC. Such architecture may be suitable for Industrial Control System (ICS) used for local monitoring and controlling industrial processes in a single site. This conventional ICS, often refer to as local area network (LAN), typically includes a computer adopted to support the protocols of all different PLCs in the local network.

Over the years the Internet network became essential for communicating control and monitoring large-scale processes spread over multiple sites, as well as remote management used, for example, for software upgrade, data acquisition or the like. To enable the exchange of data over the Internet between multi-vendor PLC devices and control applications without proprietary restrictions an OLE (Object Linking and Embedding) for Process Control (OPC) server is commonly used. The OPC server supports continuous real-time communication among PLCs and between PLCs with Human Machine Interface (HMI) software applications. The OPC server is a software program implemented in client/server pairs utilized for converting PLC's hardware communication protocol into an OPC protocol. The OPC client software may be a program that needs to connect to the hardware, such as an HMI or SCADA. The OPC client uses the OPC server to get data from or send commands to the hardware.

### BRIEF SUMMARY

According to an aspect of the present disclosed subject matter, A gateway configured to control and monitor a plurality of control elements (CE), the gateway comprising: application programming interface (API) for communicating with applications over the internet; libraries of CE's messages; and at least one interpreter utilized for translating the messages into an API protocol and vice versa.

In some exemplary embodiments, the gateway is configured to control and monitor a plurality of CEs and at least one network element, having user's interface, within a local control network (LCN).

In some exemplary embodiments, the gateway utilizes API protocol to communicate messages with gateways and user's interfaces of remote LCNs.

In some exemplary embodiments, the libraries comprising a verity of lists each having a proprietary and/or standard based CE's messages.

In some exemplary embodiments, the at least one interpreter is utilized for translating the messages from one protocol to another protocol.

In some exemplary embodiments, the LCN further comprises a plurality of network elements selected from a group comprising of: printers, computers, displays, switches, cameras, and a combination thereof,

In some exemplary embodiments, the plurality of network elements communicate with the gateway over wired and/or wireless media.

In some exemplary embodiments, the gateway police ingress and egress traffic by utilizing periodic polling scheme on both the LCN side of the gateway and a wide area network (WAN) side of the gateway, thereby avoiding traffic congestion.

In some exemplary embodiments, communication between network elements, CEs and a combination thereof, is govern by polling communication scheme of the gateway, thereby protecting the gateway with ingress and egress firewalls.

In some exemplary embodiments, the gateway utilizes API protocols for communicating trough the cloud directly with relevant API and remote LCNs without servers commission.

According to another aspect of the present disclosed subject matter, a system configured to communicate messages between a plurality of local control networks (LCN), the system comprising: at least one gateway, wherein each gateway of the at least one gateway is configured to control and monitor a plurality of control elements; at least one cloud computing service (CCS) adapted to enable each gateway of the at least one gateway to address an application of choice via web application programming interface (API) regardless of the location of LCN; and a user's interface deployed on at least one network element, wherein each user's interface of the at least one network element can utilize a different operating system and may be utilizing different control and monitoring applications.

In some exemplary embodiments, the CCS utilization of API protocols obviates open platform communications servers, thereby minimizing potential security breaches.

### BRIEF DESCRIPTION OF THE DRAWINGS

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only, and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter may be embodied in practice.

In the drawings:

FIG. 1 shows an architecture of data communication scheme commonly used for controlling and monitoring PLCs over the Internet; and

FIG. 2 shows a block diagram of a local control network, in accordance with some exemplary embodiments of the disclosed subject matter;

### DETAILED DESCRIPTION

Before explaining at least one embodiment of the disclosed subject matter in detail, it is to be understood that the disclosed subject matter is not limited in its application to the details of construction and the arrangement of the components set forth in the following description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, non-essential elements were omitted from some of the drawings.

The terms “comprises”, “comprising”, “includes”, “including”, and “having” together with their conjugates mean “including but not limited to”. The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this disclosed subject matter may be presented in a range format. It should be understood that the description in range format is merely for convenience and brevity and should not be construed as an inflexible limitation on the scope of the disclosed subject matter. Accordingly, the description of a range should be considered to have specifically disclosed all the possible sub-ranges as well as individual numerical values within that range.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable sub-combination or as suitable in any other described embodiment of the disclosed subject matter. Certain features described in the context of various embodiments are not to be considered essential features of those embodiments, unless the embodiment is inoperative without those elements.

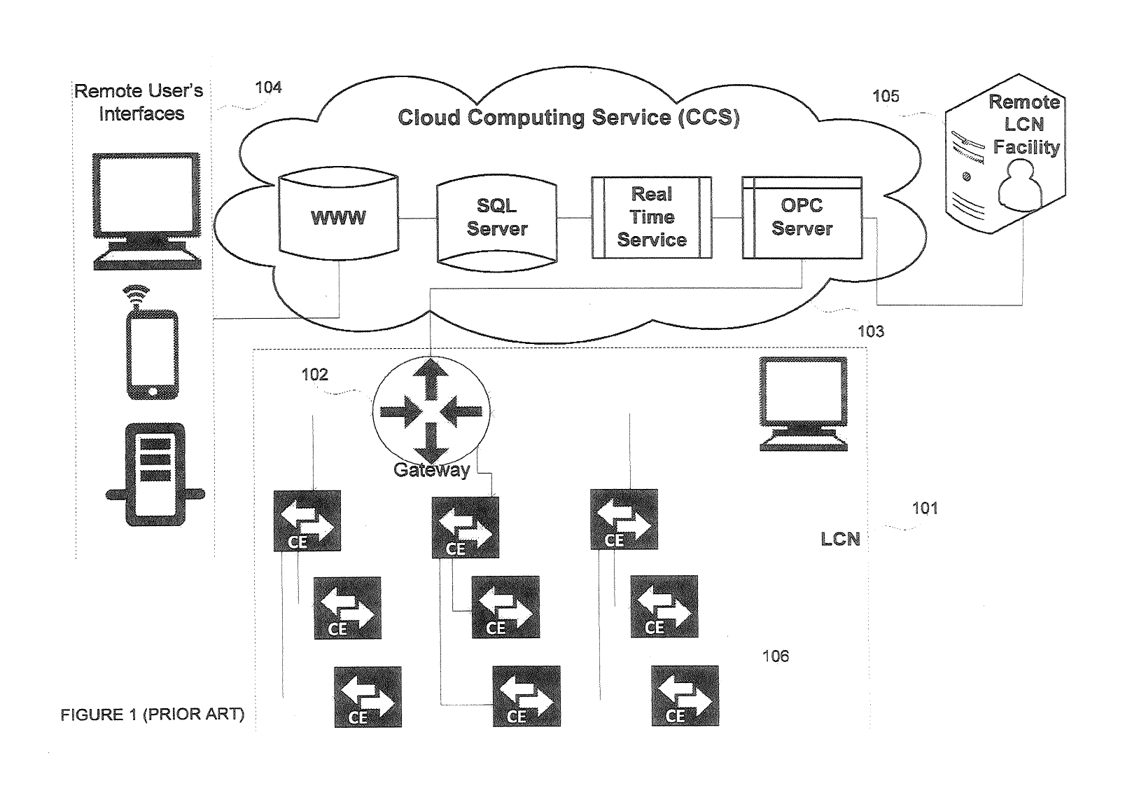

One technical problem dealt with by the disclosed subject matter is a potential security breach to a Local Control Networks (LCN), such as for example, a LAN, and ICS, a combination thereof, or the like. The security breach may be caused by opening a port in a router, such as Gateway 102 shown in FIG. 1, in order to enable remote control and monitoring of a Control Element (CE), such as CE 106 shown in FIG. 1, in the LCN. Due to the significant growth of Internet connectivity Local Control Networks such as LCN 101 shown in FIG. 1, became vulnerable for breaching of malicious software trough the Wide Area Network (WAN) which results in an increased risk of cyber-based attacks impacting industries and human safety.

It should be noted that in the present disclosure the terms “Control Elements” (CE) is referring to a network element capable of receiving and transmitting data along a network on at least one end while controlling and monitoring an apparatus or a physical processes on another end. A CE may be for example a PLC; a Digital Video Recorder (DVR); a Distributed Control System (DCS), a combination thereof, or the like.

Another technical problem dealt with by the disclosed subject matter is the extensive and lengthily deployment effort and the costs associated with utilizing an OPC server and its Real Time Service (RTS). In some commercially available solutions OPC and RTS may be deployed in a Cloud Computing Service (CCS) as shown in FIG. 1 and are utilized for interpreting proprietary and standard based communication protocols to OPC protocol and vice versa. On the other end the OPC server translates instructions of user's interface applications, such as for example HMI, SCADA, performed by remote clients such as by Remote User's Clients 104 shown in FIG. 1.

Yet another technical problem dealt with by the disclosed subject matter is securing an OPC deployment. The OPC's Inherent architectural complexity, lack of security posture, ambiguous security guidelines, freely available open protocol specifications and the security development struggle are all contributing to the difficulties of securing OPC deployments.

Yet another technical problem dealt with by the disclosed subject matter is dealing with traffic congestion caused by the increase in the volume of use of CE and LCNs. Another contributing factor to traffic congestion is that currently available routers such as Gateway 102 allow for network elements both on the LAN and WAN sides to initiate traffic session, subsequently increases traffic congestion.

It should be noted that in the present disclosure the terms “Router” and “Gateway” are mutually used for referring to a device utilized for communicating data packets along networks. The device may be connected to at least two networks, commonly known as LAN and WAN and may forward data packets within each network, between networks, a combination thereof, or the like.

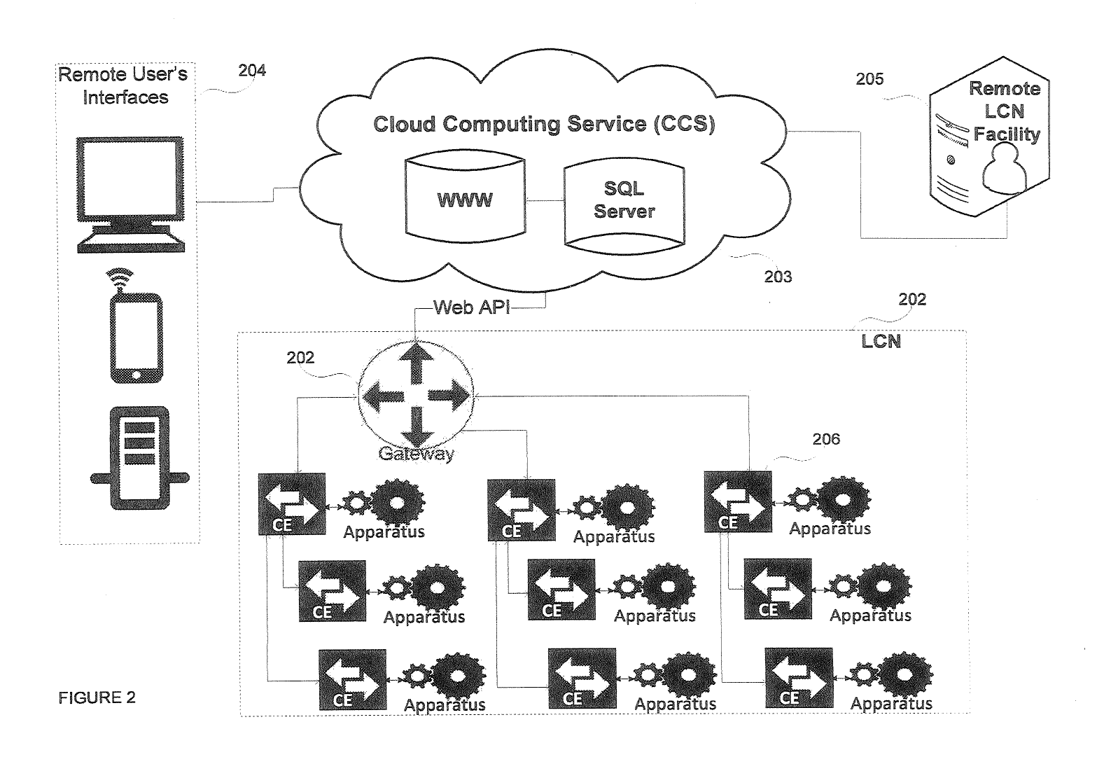

One technical solution is by enhancing LCN such as LCN 201 of FIG. 2 with a Gateway for Distributed Control Network (GDCN) such as GDCN 202 of FIG. 2. In some exemplary embodiments of the disclosed subject matter, the GDCN 202 may support Web Application Programming Interface (API) protocol such as for example a Simple Object Access Protocol (SOAP), a Representational State Transfer (REST), a combination thereof; or the like.

Another technical solution is alleviating the LCN from the dependency on OPC server for translating communication protocols. In some exemplary embodiments, the GDCN maintain libraries of proprietary and standard based CE's protocols and may be equipped with the capability of translating messages based on the CE's protocol into a Web API messages. Additionally or alternatively the GDCN may be equipped with the capability of converting Web API messages from the Web Server to proprietary and standard based CE protocol.

Yet another technical solution is policing the ingress and egress traffic activity on the WAN side of the LCN thereby, avoiding traffic congestion. In some exemplary embodiments, the GDCN may police traffic activity by utilizing periodic polling scheme on communication requests for both the CEs and the Web Server. The periodic polling scheme may turn the GDCN into the sole entity in the LCN that is capable of initiating communication with CEs, Web API, and foreign GDCNs. Foreign GDCN may be GDCN that is managing the traffic of remote LCN such for example a Remote LCN Facility 205 of FIG. 2. Additionally or alternatively the GDCN may periodically monitor all network elements at its discretion both on WAN and LAN side and subsequently initiate fetch and store cycles. In some exemplary embodiments, the GDCN act as a bridge between two or more CEs of remote LCNs situated in local facility remote facility, a combination thereof, or the like.

One technical effect of utilizing the disclosed subject matter is reducing potential security breach by sealing the WAN loophole of the LCN. In some exemplary embodiments, the need for opening a port in the router, for remote control and monitoring the LCN may not be necessary due to the polling communication scheme. As a result, the GDCN may be the sole entity in the LCN that is capable of initiating communication both in the LAN and WAN side, thus the GDCN surrounds itself by firewalls blocking any incoming and outgoing session requests. Additionally or alternatively the disclosed subject matter may further minimize potential security breaches by neutralizing security issues associated with the OPC server. In some exemplary embodiments the GDCN may use protocols, such as SOAP, REST or the like coupled with utilizing its libraries for translating different protocols messages to communicate directly with Web-API in order to avoid the OPC server.

Another technical effect of utilizing the disclosed subject matter is reducing the cost and the deployment time associated with OPC server and its associated RTS. In some exemplary embodiments of the disclosed subject matter, a GDCN may perform the activities associated to OPC and RTS by converting CE hardware communication protocol into an API and vice versa. Thereby, communicating trough the cloud directly with the relevant API without the OPC commission.

Yet another technical effect of utilizing the disclosed subject matter is a reduction of traffic congestion. In some exemplary embodiments, the GDCN may control ingress and egress traffic activity of the LCN by utilizing a periodic polling scheme for communicating messages to and from both the CEs and the Web Server. The GDCN periodic polling scheme may monitor statuses, changes, commands and requests of CEs as well as other network elements connected to it on both the LCN and WAN sides. The GDCN may also arbitrate priorities between its network elements, collect from them information and broadcast to them messages.

Referring now to FIG. 2, showing a block diagram of a local control network in accordance with some exemplary embodiments of the disclosed subject matter.

LCN 202 may be a Local Control Network comprising one or more Control Elements (CE), one or more apparatuses, a Gateway for Distributed Control Network (GDCN) and Network Elements (NE) (not shown), such as for example, printers, computers, displays, switches, cameras, a combination thereof, or the like. In some exemplary embodiments, a portion of the NEs and CEs may be connected to the GDCN by wires utilizing Ethernet protocols MODBUS protocol or the like. In some exemplary embodiments, a portion of the NEs and CEs may be wirelessly connected to the GDCN utilizing Wi-Fi protocol, Bluetooth protocol, or the like.

In some exemplary embodiments of the disclosed subject matter, the CE may be used to control and monitor an Apparatus. The Apparatus may be a machine performing continuous processes, batch processes, a combination thereof, or the like. Typical continuous processes include fuel or steam flow in a power plant, petroleum in a refinery, and distillation in a chemical plant. Typical batch processes may be food manufacturing and electronic device assembly. The Apparatus may be consisting of sensors for measurement, actuators such as control valves, breakers, switches and motors, or the like. In some exemplary embodiments, the CE interprets the sensors information and generates corresponding manipulated variables, based on set points, which it transmits to the actuators. The CE may communicate variables indicating the status of the apparatus as well as instruction to the apparatus.

In some exemplary embodiments of the disclosed subject matter, GDCN 202 may be a router equipped with the capability to utilize API protocols, such as SOAP REST in order to communicate directly with Web applications over the internet.

It should be noted that in the disclosed subject matter the term “protocol” is a method of conveying messages; such as command, control, values, status a combination thereof, or the like between network elements.

wherein the libraries comprising a verity of lists each having a proprietary and/or standard based CE's messages.

In some exemplary embodiments, the GDCN may comprise libraries, wherein the libraries encompass a verity of lists each having a proprietary and/or standard based CE's messages. In addition, the GDCN may comprise an interpreter utilized by a GDCN for translating proprietary and standard CE's messages into a Web API messages and vice versa.

Remote Facility LCN 205 may be an LCN performing equivalent functionalities as LCN 201. In some exemplary embodiments, CEs and NEs of LCN 201 may communicate with CEs and NEs of Remote Facility LCN 205 and other Remote Facility LCN (not shown).

User's Interface (UI) 204 may be a computing device, such as for example, a personal computer, a Smartphone, a Tablet device a, 3rd party System, a combination thereof, or the like. In some exemplary embodiments, the UI may be used as remote terminal for monitoring and controlling one or more apparatuses of LCNs such as LCN 202. It should be noted that each UI device may be running on a different operating system and may be utilizing different control and monitoring applications, such as Supervisory Control and Data Acquisition (SCADA) or any commercially available Human Machine Interface (HMI).

In some exemplary embodiments, Cloud Computing Service (CCS) 203 may be computing service allowing software applications to be operated using Internet-enabled devices. Cloud Computing Service such as for example the Amazon Web Service (AWS) may be utilized to access servers, storage, databases and a broad set of application services over the Internet. Thus, enabling the GDCN to address the application of choice via web API regardless of the location of LCN it is serving.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

1. A gateway configured to control and monitor a plurality of control elements (CE), the gateway comprising:
application programming interface (API) for communicating with applications over the internet;
libraries of CE's messages; and
at least one interpreter utilized for translating the messages into an API protocol and vice versa.

2. The gateway of claim 1, wherein the gateway is configured to control and monitor a plurality of CEs and at least one network element, having user's interface, within a local control network (LCN).

3. The gateway of claim 2, wherein the gateway utilizes API protocol to communicate messages with gateways and user's interfaces of remote LCNs.

4. The gateway of claim 1, wherein the libraries comprising a verity of lists each having a proprietary and/or standard based CE's messages.

5. The gateway of claim 1, wherein the at least one interpreter is utilized for translating the messages from one protocol to another protocol.

6. The gateway of claim 1, wherein the LCN further comprises a plurality of network elements selected from a group comprising of: printers, computers, displays, switches, cameras, and a combination thereof,

7. The gateway of claim 6, wherein the plurality of network elements communicate with the gateway over wired and/or wireless media.

8. The gateway of claim 1, wherein the gateway police ingress and egress traffic by utilizing periodic polling scheme on both the LCN side of the gateway and a wide area network (WAN) side of the gateway, thereby avoiding traffic congestion.

9. The gateway of claim 8, wherein communication between network elements, CEs and a combination thereof, is govern by polling communication scheme of the gateway, thereby protecting the gateway with ingress and egress firewalls.

10. The gateway of claim 1, wherein the gateway utilizes API protocols for communicating trough the cloud directly with relevant API and remote LCNs without servers commission.

11. A system configured to communicate messages between a plurality of local control networks (LCN), the system comprising:
at least one gateway, wherein each gateway of the at least one gateway is configured to control and monitor a plurality of control elements;
at least one cloud computing service (CCS) adapted to enable each gateway of the at least one gateway to address an application of choice via web application programming interface (API) regardless of the location of LCN; and
a user's interface deployed on at least one network element, wherein each user's interface of the at least one network element can utilize a different operating system and may be utilizing different control and monitoring applications.

12. The system of claim 11, wherein the CCS utilization of API protocols obviates open platform communications servers, thereby minimizing potential security breaches.
